(19) United States
(12) Patent Application Publication
(10) Pub. No.: US 2012/0007955 A1
(43) Pub. Date: Jan. 12, 2012

(54) PORTABLE AUXILIARY DEVICE FOR MAKING STEREOSCOPIC IMAGE

(76) Inventor: DANIEL ROBERT FRADENBURGH, BARRIE (CA)

(21) Appl. No.: 12/832,317

(22) Filed: Jul. 8, 2010

(51) Int. Cl. H04N 13/02

(52) U.S. Cl. 348/47; 348/E13.074

(57) ABSTRACT

In a portable auxiliary device for making stereoscopic image, a first rotatable assembly and a second rotatable assembly are rotatably mounted on an operation platform, and further respectively mounted with a first image catching device and a second image catching device thereon; a first optical guiding member and a second optical guiding member are respectively connected to the first rotatable assembly and the second rotatable assembly, and further respectively projects a first guiding light beam and a second guiding light beam. When the first rotatable assembly and the second rotatable assembly is operated to make the first guiding light beam and the second guiding light beam converged in a guided convergent position, a first optical axis of the first image catching device and a second optical axis of the second image catching device are simultaneously aligned to converge in a set convergent position.

### BACKGROUND OF THE INVENTION

In the traditional technologies, only one optical system is applied to catch images, thus only two-dimensional (2D) visual effect can be presented by the images. However, generally speaking, the visual system of human beings prefers to receive three-dimensional image because it is composed of two eyes, which are equivalent to two optical systems. Especially, after stereoscopic (three-dimensional; 3D) image technologies are widely applied in stereo movies, live broadcasts of sports, etc., the stereoscopic images and video have become more and more popular over the world.

Under this background, for making the images or video capable of presenting stereoscopic effects, some 3D optical image catching devices, such as 3D digital cameras, 3D digital video cameras, etc., have been developed. Among the 3D optical image catching devices, each one shall be installed with two independent optical lens assemblies, which are performed as two independent optical systems. In another kind of image catching devices, one or two camera(s), and the use of fragile elements such as at least one mirror, and/or at least one prism, and/or at least one half-mirror may be used, but it is necessary to be additionally installed with at least one external lighting system to overcome the problem that the image will become darker, and the installation of the external lighting system will also increase the cost.

In a representative prior art to configure a 3D optical image catching devices, two optical systems have to be independently installed according to two parallel optical axes, the two optical systems have to be operated to simultaneously align their focusing positions, hereafter, two images or videos can be respectively caught by the two optical systems. Then a 3D image or a 3D video can be made according to the two images or videos. Because the two optical axes are parallel to each other without converging in a position, the two images or videos still need to be corrected before they are combined to produce the 3D image or video. In general, the correction and the combination are executed by a complex program installed in an electronic device.

However, in practice, it is very difficult to manufacture the 3D optical image catching devices independently installed with the two optical systems therein, because it makes the structure of the 3D optical image catching devices become very complicated. Nevertheless, for executing the correction and the combination as mentioned, more additional means, such as initial calibration means, are necessary, and the additional means not only make the structure of the 3D optical image catching devices becomes more complicated, but also make the calculation of the program become more complex. More important, it not only makes the 3D optical image catching devices become more expensive, but also makes the operation steps become more and more complex for the user. Additionally, for the huge film cameras, it is would be better to make the optical systems converge optically rather than digitally; thus, the present invention intends to afford the ability of optical convergence to users under the condition that they just need to mount the common retail video cameras on a simplified portable auxiliary device.

Under above background, the inventor is deeply of the opinion that it is necessary to develop the simplified portable auxiliary device be capable of mounting two traditional optical image catching devices, each only has one optical axis for image catching. Through the development of the portable auxiliary device, the two traditional optical image catching devices can be guided to face toward a set convergent position to make both the two optical axes of the two traditional optical image catching devices be simultaneously adjusted to converge in the set convergent position. Under this situation, the two traditional optical image catching devices can catch two images or videos toward the set convergent position to accordingly produce stereoscopic images or videos.

### SUMMARY OF THE INVENTION

In the prior arts, for the purpose of making stereoscopic images, it is almost unavoidable to install two independent optical systems within a 3D image catching device, and it must cause the result that the structure and the calculation of the program of the 3D image catching device become more complex. Thus, the primary of the present invention is to provide a portable auxiliary device capable of mounting two optical image catching devices, each just has one optical axis for image catching. Using the portable auxiliary device as provided in the present invention, the two optical axes of the two optical image catching devices can be guided to be converged to a set convergent position via simple manual operation, so as to aid the user to catch at least two images to make a stereoscopic image.

Means of the present invention for solving the problems as mentioned above provides a portable auxiliary device for making at least one stereoscopic image after mounted with a first image catching device and a second image catching device. The portable auxiliary device includes an operation platform, a first rotatable assembly, a second rotatable assembly, a first optical guiding member and a second optical guiding member. The operation platform has an operation plane for rotation. The first rotatable assembly is rotatably mounted on the operation platform for mounting the first image catching device, which has a first optical axis for image catching, thereon. The second rotatable assembly is rotatably mounted on the operation platform for mounting the second image catching device, which has a second optical axis for image catching, thereon. The first optical guiding member is connected to the first rotatable assembly for projecting a first guiding light beam vertically parallel to the first optical axis. The second optical guiding member is connected to the second rotatable assembly for projecting a second guiding light beam vertically parallel to the second optical axis.

When a user rotates the first rotatable assembly and/or the second rotatable assembly to make the first guiding light beam and the second guiding light beam converge in a guided convergent position, the first optical axis and second optical axis are simultaneously aligned to converge in a set convergent position, so as to aid the first image catching device and the second image catching device respectively catching at least one first image and at least one second image toward the set convergent position, and further to make at least one stereoscopic image according to the first image and the second image.

In the preferred embodiment of the present invention, the first/second rotatable assembly further includes a rotatable plate and a bracket. The rotatable plate is rotatably mounted on the operation platform, for mounting the first/second image catching device thereon. The bracket is bored with an alignment slot for slidably aligning the first optical guiding member to make the projection of the first guiding light beam be coaxial with the projection of the first optical axis with respect to the operation plane. The first optical guiding member and/or the second optical guiding member can be a laser emitter, and the first guiding light beam and/or the second guiding light beam can a laser light beam. The first/second image catching device is a camera, video camera, or digital video camera. The first/second image can be a motion image or a static image.

Preferably, the portable auxiliary device further includes a quick release mechanism assembled to the rotatable plate and the operation platform, so the user can quickly mount the rotatable plate on the operation platform or quickly remove the first rotatable plate from the operation platform. More preferably, the quick release mechanism can include a latching member and a quick release bar, and the latching member can be provided with a rotatable portion and a driving portion. The rotatable portion is operated to perforate through the operation platform, and formed in a rounded periphery to make the rotatable portion be rotatable with respect to the operation platform. The driving portion is extended from the rotatable portion, bored with a latching recess, and formed in a non-rounded periphery. The quick release bar is operated to perforate the rotatable plate to latch the latching recess when mounting the rotatable plate on the operation platform; it is operated to release from the latching recess when removing the rotatable plate from the operation platform. For making the operation of the latching and the removal of the quick release bar become more convenient, the latching recess can be a tapered latching recess, and the quick release bar can have a tapered portion in one end to fit for the tapered latching recess.

Comparing with the conventional technologies of making the stereoscopic images as disclosed in prior arts, in the present invention, it just needs to mount two optical image catching devices (i.e. the first image catching device and the second image catching device), each just has one optical axis for image catching, on two rotatable assemblies (i.e. the first rotatable assembly and the second rotatable assembly) respectively assembled with two optical guiding members (i.e. the first optical guiding member and the second optical guiding member). Therefore, the user can easily rotate the first rotatable assembly and/or the second rotatable assembly to make the first guiding light beam and the second guiding light beam converged in a guided convergent position to make the first optical axis and second optical axis be simultaneously aligned to converge in a set convergent position. It is obvious that through above simple manual operation, the user can operate the first image catching device and the second image catching device to respectively catch at least one first image and at least one second image toward the set convergent position, and further to make at least one stereoscopic according to the first image and the second image. In other words, through the present invention, the user can make viewable stereoscopic images in a convenient and economic way.

The devices, characteristics, and the preferred embodiments of this invention are described with relative figures as follows.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein

FIG. 1 is an explosive view of a portable auxiliary device in accordance with a preferred embodiment of the present invention;

FIG. 2 is a perspective view of a latching member of the portable auxiliary device in accordance with the preferred embodiment of the present invention;

FIG. 3 illustrates the method to mount a first image catching device on a rotatable plate, and further to quickly mount the rotatable plate onto an operation platform in accordance with the preferred embodiment of the present invention;

FIG. 4 is a cross-sectional view along A-A direction in FIG. 3, and illustrates the method to mount the first image catching device on the rotatable plate;

FIG. 5A is a cross-sectional view along B-B direction in FIG. 3, and illustrates the method to quickly mount the rotatable plate, which is mounted with the first image catching device, onto an operation platform;

FIG. 5B is a cross-sectional view along C-C direction in FIG. 5A, and illustrates the method to quickly mount the rotatable plate, which is mounted with the first image catching device, onto an operation platform;

FIG. 5C is another cross-sectional view along C-C direction in FIG. 5A, and illustrates the method to quickly mount the rotatable plate, which is mounted with the first image catching device, onto an operation platform;

FIG. 6 illustrates a perspective view after the first image catching device and the second image catching device being mounted on the portable auxiliary device in accordance with the preferred embodiment of the present invention;

FIG. 7A and FIG. 7B illustrate the guided convergent position (where the first guiding light beam and the second guiding light beam are converged) and the set convergent position (where the first optical axis and the second optical axis are converged) are located in the same projection position with respect to the operation plane; and

FIG. 8 illustrates the rotation angle of the rotatable plate can be determined by the angle graduations marked on the backward edge of the operation platform.

### DETAILED DESCRIPTION OF THE PREFERRED EMBODIMENTS

The portable auxiliary device as provided in accordance with the present invention can be widely applied to aid a user to make at least one stereoscopic image after mounted with a first image catching device and a second image catching device, and the combined applications of the present invention are too numerous to be enumerated and described; therefore only one preferred embodiment is disclosed as follows for representation.

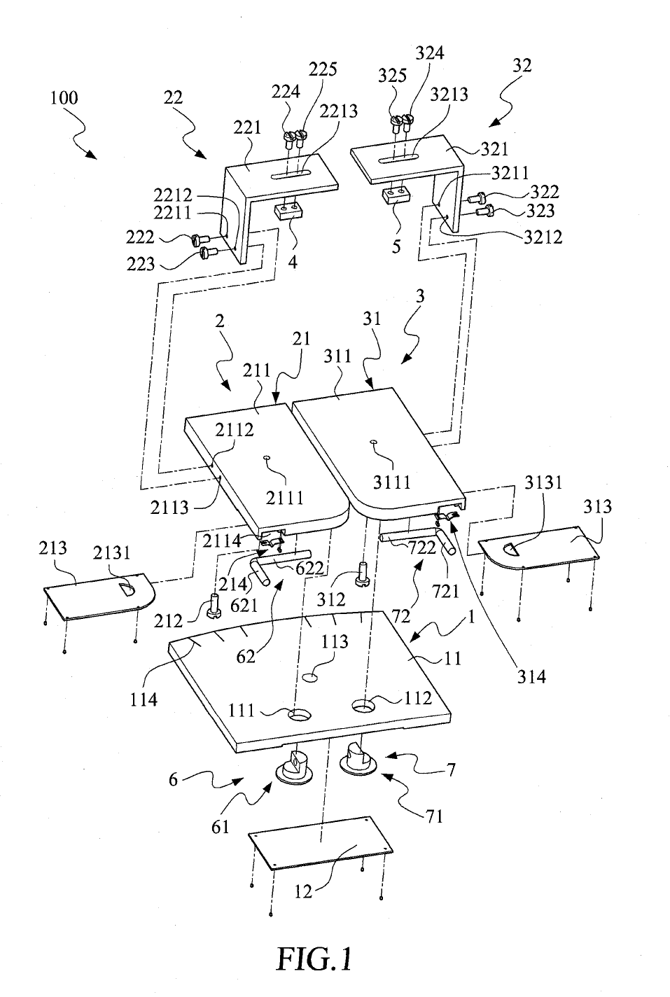

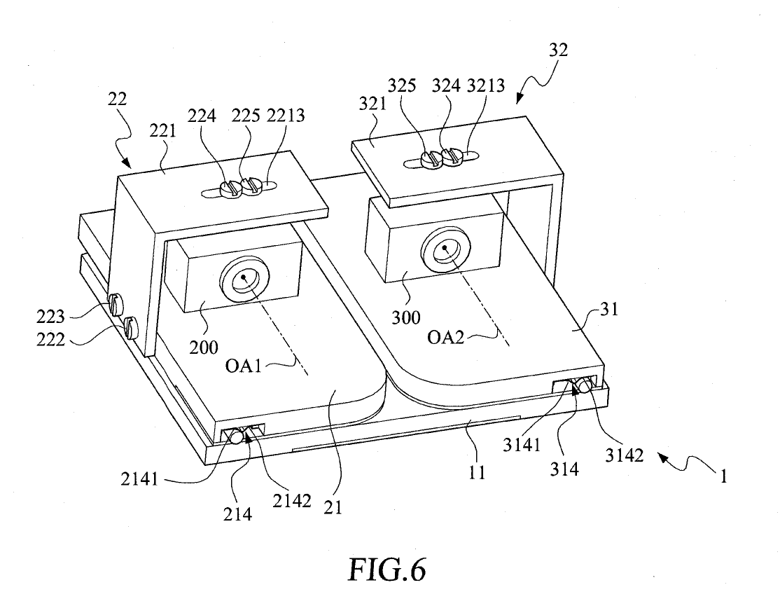

Please refer to FIG. 1, which is an explosive view of a portable auxiliary device in accordance with a preferred embodiment of the present invention. A portable auxiliary device 100 is applied to aid a user to make at least one stereoscopic image after mounting a first image catching device 200 (shown in FIG. 6) and a second imaging catching device 300 (shown in FIG. 6) thereon. The first image catching device 200 has a first optical axis OA1 for image catching, and the second image catching device 300 has a second optical axis OA2 for image catching. The portable auxiliary device 100 includes a platform 1, a first rotatable assembly 2, a second rotatable assembly 3, a first optical guiding member 4, a second optical guiding member 5, and two quick release mechanisms 6 and 7.

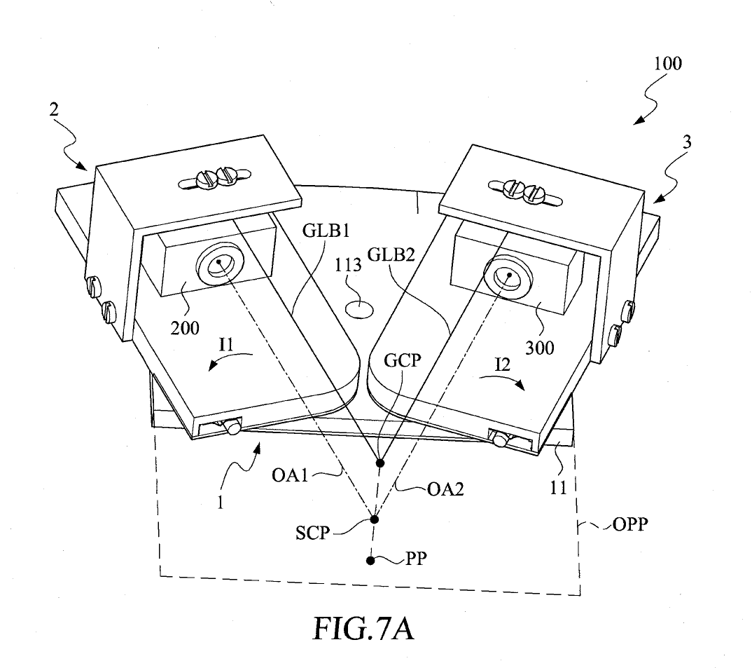

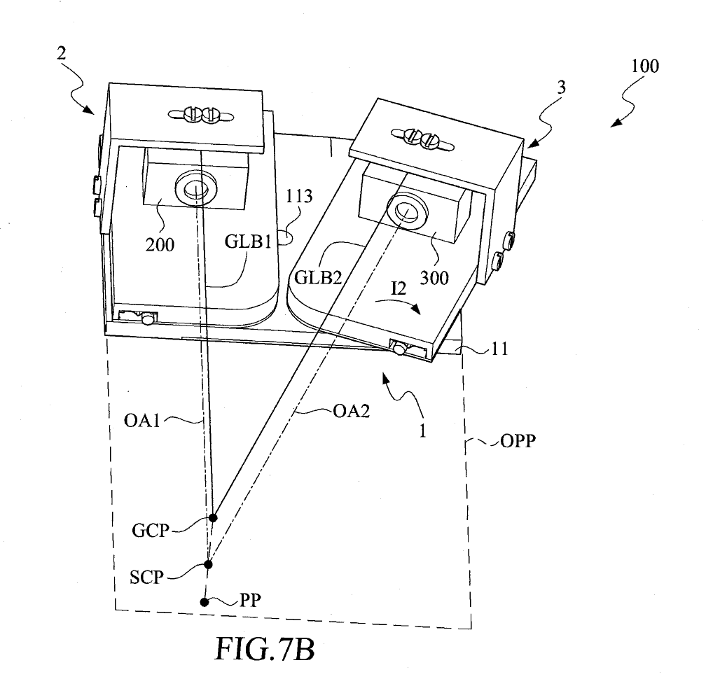

The platform 1 includes a main plate 11 and a bottom plate 12. The main plate 11 has an operation plane OPP (shown in FIG. 7) for rotation. Moreover, the main plate 11 is bored with two operation holes 111 and 112, and a connection hole 113, and further marked with a plurality of angle graduations 114 along its backward edge.

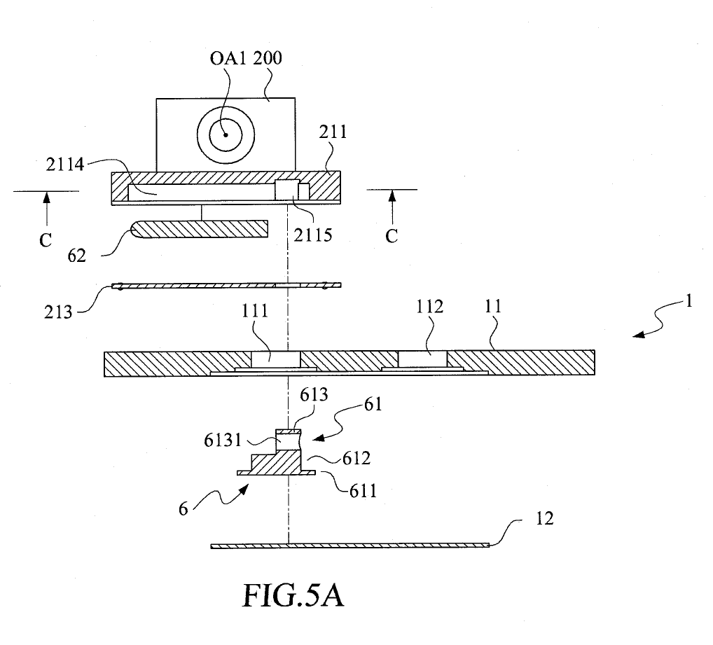

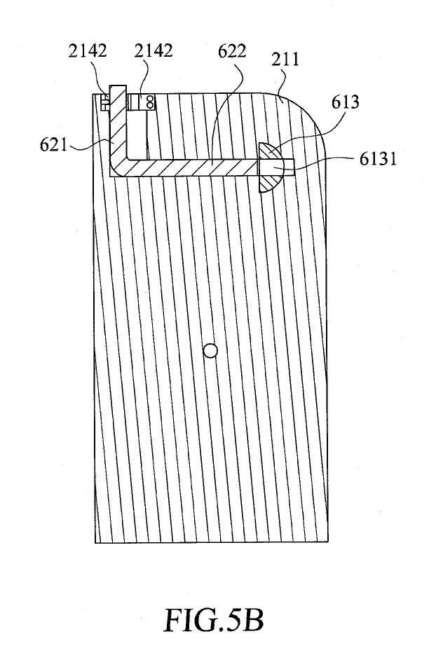

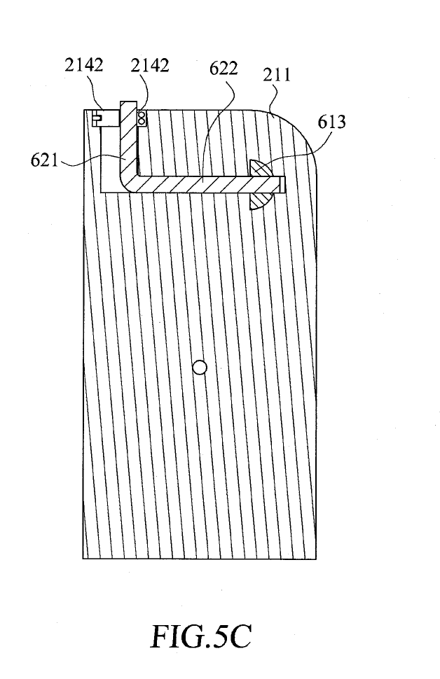

The first rotatable assembly 2 includes a rotatable plate 21, and a bracket 22. The rotatable plate 21 includes a securing plate 211, a fastening screw 212, a bottom plate 213 and a flexible positioning plate 214. The securing plate 211 is bored with three connection holes 2111, 2112 and 2113, a latching passageway 2114 and a driving recess 2115 (shown in FIG. 5A). The connection hole 2111 is applied for the fastening screw 212 perforating though to fasten the first image catching device 200 (shown in FIG. 6). The connection holes 2112 and 2113 are located in the outer side (away from the second rotatable assembly 3) of the securing plate 211. The latching passageway 2114 is an L-shaped passageway having a positioning opening on the front side of the securing plate 211. The driving recess 2115 is formed in a non-rounded periphery, herein is formed in a semi-circle periphery, and spatially communicated with the latching passageway 2114 within the securing plate 211 (shown in FIG. 5). The bottom plate 213 is assembled to the securing plate 211, and bored with a driving hole 2131 formed in a non-rounded periphery, herein is formed in a semi-circle periphery fitted for the driving recess 2115. The flexible positioning plate 214 is fitted nearby the positioning opening and has two positioning portions 2141 and 2142 (shown in FIG. 5B-FIG. 6).

The bracket 22 can be formed in an L-shaped structure, and includes a bracket body 221 and four fastening screws 222, 223, 224 and 225. The bracket body 221 is bored with two connection holes 2211 and 2212, and an alignment slot 2213. The fastening screws 222 and 223 are applied to perforate though the connection holes 2211 and 2212 to make the bracket 22 assembled to the rotatable plate 21. The fastening screws 224 and 225 are applied to perforate though the alignment slot 2213 to make the first optical guiding member 4 slidably assembled to the bracket 22.

Similarly, the second rotatable assembly 3 includes a rotatable plate 31 and a bracket 32. The rotatable plate 31 includes a securing plate 311, a fastening screw 312, a bottom plate 313, and a flexible positioning plate 314. The securing plate 311 is bored with three connection holes (one of them is the connection hole 3111, the remaining two connection holes are not shown), a latching passageway (not shown) and a driving recess (not shown). The connection hole 3111 is applied for the fastening screw 312 to perforate though to fasten the second image catching device 300 (shown in FIG. 6). The remaining two connection holes are located in the outer side (away from the first rotatable assembly 2) of the securing plate 311. The latching passageway of the securing plate 311 is also an L-shaped passageway having a positioning opening on the front side of the securing plate 311. The driving recess is spatially communicated with the latching passageway within the securing plate 311. The bottom plate 313 is assembled to the securing plate 311 and bored with a driving hole 3131 formed in a non-rounded periphery, herein is formed in a semi-circle periphery fitted for the driving recess of the securing plate 311. The flexible positioning plate 314 is fitted nearby the positioning opening and has two positioning portions 3141 and 3142 (shown in FIG. 5B-FIG. 6).

The bracket 32 can be formed in an L-shaped structure, and includes a bracket body 321 and four fastening screws 322, 323, 324 and 325. The bracket body 321 is bored with two connection holes 3211 and 3212, and an alignment slot 3213. The fastening screws 322 and 323 are applied to perforate though the rest two connection holes of the securing plate 311 to make the bracket 32 assembled to the rotatable plate 31. The fastening screws 324 and 325 are applied to perforate though the alignment slot 3213 to make the second optical guiding member 5 slidably assembled to the bracket 32.

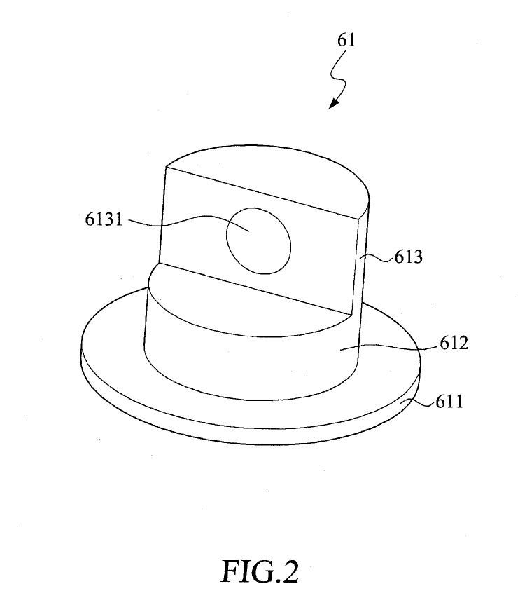

Please refer to FIG. 2, which is a perspective view of a latching member of the portable auxiliary device in accordance with the preferred embodiment of the present invention, and also refer to FIG. 1 at the same time. The quick release mechanism 6 includes a latching member 61 and a quick release bar 62. The latching member 61 includes a base portion 611, a rotatable portion 612 and a driving portion 613. The rotatable portion 612 is extended from the base portion 611, and formed in a rounded periphery to make itself be rotatable with respect to the operation platform 1. The driving portion 613 is extended from the rotatable portion 612, formed in a non-rounded periphery, herein is formed in a semi-circle periphery, fitted for the driving recess 2115, and bored with a latching recess 6131. The quick release bar 62 is formed in L-shape having a switching portion 621 and a latching portion 622 perpendicularly bent from the switching portion 621, and is inserted to the latching passageway 2114. The switching portion 621 can be switched to be positioned in the positioning portion 2141 or 2142 (shown in FIG. 5B) of the flexible positioning plate 214.

Similarly, the quick release mechanism 7 includes a latching member 71 and a quick release bar 72. The quick release bar 72 is formed in L-shape having a switching portion 721 and a latching portion 722 perpendicularly bent from the switching portion 721, and is inserted to the latching passageway of the rotatable plane 71. Because the quick release mechanism 7 is similar to or the same as the quick release mechanism 6 in structural, the related description of quick release mechanism 7 will not be repeated again.

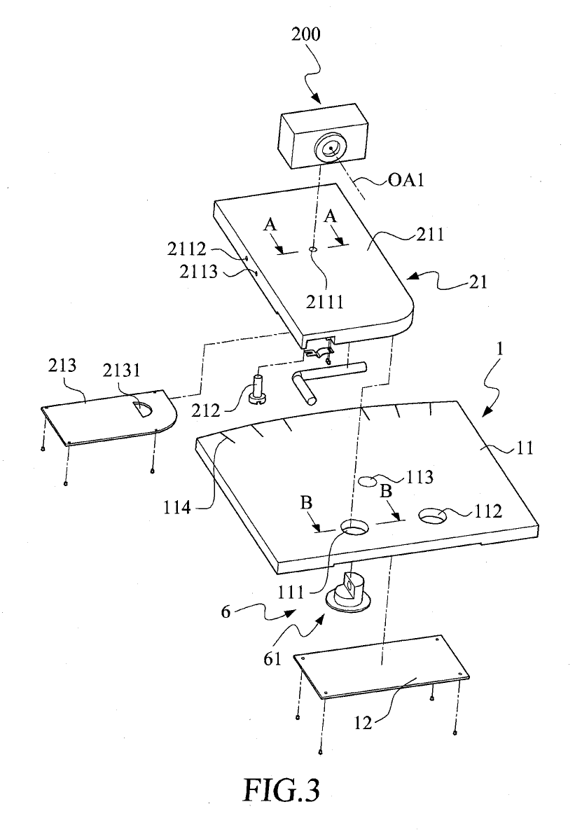

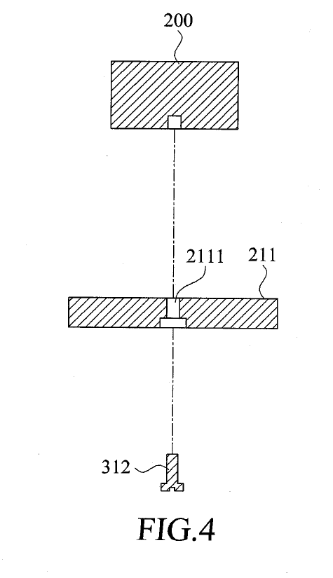

Please refer to FIG. 3 to FIG. 5C, wherein FIG. 3 illustrates the method to mount a first image catching device on a rotatable plate, and further to quickly mount the rotatable plate onto an operation platform in accordance with the preferred embodiment of the present invention; FIG. 4 is a cross-sectional view along A-A direction in FIG. 3, and illustrates the method to mount the first image catching device on the rotatable plate; FIG. 5A is a cross-sectional view along B-B direction in FIG. 3, and illustrates the method to quickly mount the rotatable plate, which is mounted with the first image catching device, onto an operation platform; FIG. 5B is a cross-sectional view along C-C direction in FIG. 5A, and illustrates the method to quickly mount the rotatable plate, which is mounted with the first image catching device, onto an operation platform; and FIG. 5C is another cross-sectional view along C-C direction in FIG. 5A, and illustrates the method to quickly mount the rotatable plate, which is mounted with the first image catching device, onto an operation platform. As shown in FIG. 4, when mounting the first image catching device 200 on the rotatable plate 21, it is necessary to perforate the fastening screw 212 through the connection hole 2111 to fasten the image catching device 200.

As shown in FIG. 5A-FIG. 5C, after the first image catching device 200 is mounted onto the rotatable plate 21, the latching member 61 needs to be perforated through the operation holes 111 to insert into the driving recess 2115 and the bottom plate 12 needs to be assembled to the main plate 11. Once accomplished, the user can switch the switching portion 621 from the positioning portion 2141, as shown in FIG. 5B, to the other positioning portion 2142 to make the latching portion 622 insert and perforate through the latching recess 6131 of the latching member 61 as shown in FIG. 5C, so as to quickly mount the rotatable plate 21 onto the operation plate 1. Because the rotatable portion 612 is formed in the rounded periphery, the latching member 61 can be rotatable with respect to the main plate 11 of the operation platform 1. Moreover, because the driving portion 613 is formed in the non-rounded periphery fitted for the driving recess 2115 latched by the quick release bar 62, the latching member 61 can be rotatable with respect to the main plate 11 of the operation platform 1, and further can drive the securing plate 211 of rotatable plate 21 rotating together with the latching member 61.

Similarly, the second image catching device 300 can be mounted onto the rotatable plate 31, and the rotatable plate 31 can be quickly mounted to the operation plate 1, and the perspective view after the first image catching device 200 and the second image catching device 300 being mounted on the portable auxiliary 100 is presented as FIG. 6.

Please refer to FIG. 7A, which illustrates the guided convergent position (where the first guiding light beam and the second guiding light beam are converged) and the set convergent position (where the first optical axis and the second optical axis are converged) are located in the same projection position with respect to the operation plane. As shown in FIG. 7A, before catching images by the first image catching device 200 and the second image catching device 300, it is necessary to make the first optical guiding member 4 and the second optical guiding member 5 respectively project a first guiding light beam GLB1 and a second guiding light beam GLB2.

Then, it is necessary to sildably align the first optical guiding member 4 to make the first guiding light beam GLB1 be vertically parallel to the first optical axis OA1, and further make the projection of the first guiding light beam GLB1 be coaxial with the projection of the first optical axis OA1 with respect to the operation plane OPP. Similarly, it is also necessary to sildably align the second optical guiding member 5 to make the second guiding light beam GLB2 be vertically parallel to the second optical axis OA2, and further make the projection of the second guiding light beam GLB2 be coaxial with the projection of the second optical axis OA2 with respect to the operation plane OPP.

After properly aligning the first optical guiding member 4 and the second optical guiding member 5, the user can rotate the rotatable plate 21 of the first rotatable assembly 2 and/or rotate the rotatable plate 31 of the second rotatable assembly 3 to make the first guiding light beam GLB1 and the second guiding light beam GLB2 converged in a guided convergent position GCP. At the same time, the first optical axis OA1 and the second optical axis are simultaneously aligned to converge in a set convergent position SCP. In this situation, both the projection of the guided convergent position GCP toward operation plane OPP and the projection of the set convergent position SCP toward operation plane OPP are located in a projection position PP of operation plane OPP. At this moment, the user can operate the first image catching device 200 and the second image catching device 300 to respectively catch at least one first image and at least one second image toward the set convergent position SCP, and further can make at least one stereoscopic image according to the first image and the second image.

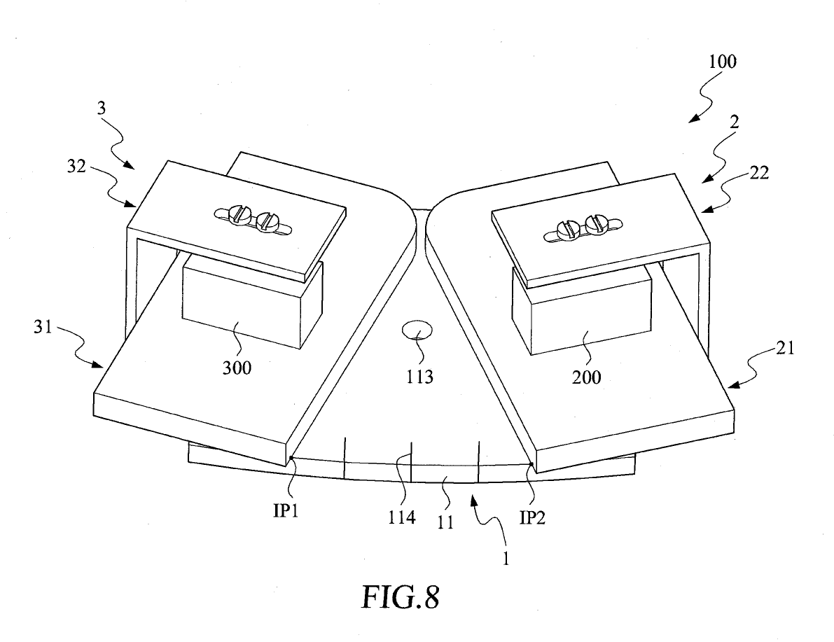

Please refer to FIG. 8, which illustrates the rotation angle of the rotatable plate can be determined by the angle graduations marked on the backward edge of the operation platform. When the user rotates the first rotatable assembly 2 and/or the second rotatable assembly 3, the rotation angles can be determined by the edge of the rotatable plate 21, the rotatable plate 31 and main plate 11 of the operation platform 1 via reading the angles of two indication points IP1 or IP2 with reference to the angle graduations 114. It needs to be further disclosed that the rotation of the first rotatable assembly 2 and/or the second rotatable assembly 3 also can be symmetrical (as shown in FIG. 7A) or asymmetrical (as shown in FIG. 7B); i.e. the rotation angles of the first rotatable assembly 2 and the second rotatable assembly 3 can be the same as or different from each other.

Finally, it needs to be further emphasized that, preferably, the first optical guiding member 4 and/or the second optical guiding member 5 can be a laser emitter, and the first guiding light beam GLB1 and/or the second guiding light beam GLB2 can be a laser light beam. The first image catching device 200 and/or the second image catching device 300 can be a camera, video camera, or digital video camera. The first image and the second image can be a motion image (video) or a static image. The stereoscopic image also can be a motion image (stereo video) or a static image.

After reading above disclosure, it is believable that any person skilled in the arts can recognize that, comparing with the conventional technologies of making the stereoscopic images or stereo videos as disclosed in prior arts, in the present invention, it just needs to mount two optical image catching devices (i.e. the first image catching device 200 and the second image catching device 300), each just has one optical axis OA1 or OA2 for image catching, on two rotatable assemblies (i.e. the first rotatable assembly 2 and the second rotatable assembly 3) respectively assembled with two optical guiding members (i.e. the first optical guiding member 4 and the second optical guiding member 5). Therefore, the user can easily rotate the first rotatable assembly 2 and/or the second rotatable assembly 2 to make the first guiding light beam GLB1 and the second guiding light beam GLB2 converged in a guided convergent position GCP to make the first optical axis OA1 and second optical axis OA2 be simultaneously aligned to converge in a set convergent position SCP. It is obvious that through above simple manual operation, the use can operate the first image catching device 200 and the second image catching device 300 to respectively catch at least one first image and at least one second image toward the set convergent position, and further to make at least one stereoscopic image according to the first image and the second image. In other words, through the present invention, the user can make the stereoscopic image in a convenient and economical way.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A portable auxiliary device provided for making stereoscopic image after mounted with a first image catching device and a second image catching device, and comprising:
an operation platform having an operation plane for rotation;
a first rotatable assembly rotatably mounted on the operation platform for mounting the first image catching device, which has a first optical axis for image catching, thereon;
a second rotatable assembly rotatably mounted on the operation platform for mounting the second image catching device, which has a second optical axis for image catching, thereon;
a first optical guiding member connected to the first rotatable assembly for projecting a first guiding light beam vertically parallel to the first optical axis; and
a second optical guiding member connected to the second rotatable assembly for projecting a second guiding light beam vertically parallel to the second optical axis;
wherein when a user rotates at least one of the first rotatable assembly and the second rotatable assembly to make the first guiding light beam and the second guiding light beam converged in a guided convergent position, the first optical axis and the second optical axis are simultaneously aligned to converge in a set convergent position, so as to aid the first image catching device and the second image catching device respectively in catching at least one first image and at least one second image toward the set convergent position, and further to make at least one stereoscopic image according to the first image and the second image.

2. The portable auxiliary device as claimed in claim 1, wherein the first rotatable assembly comprises:
a rotatable plate rotatably mounted on the operation platform, for mounting the first image catching device thereon; and
a bracket connected to the rotatable plate and assembled with the first optical guiding member.

3. The portable auxiliary device as claimed in claim 2, wherein the bracket is bored with an alignment slot for slidably aligning the first optical guiding member to make the projection of the first guiding light beam be coaxial with the projection of the first optical axis with respect to the operation plane.

4. The portable auxiliary device as claimed in claim 2, further comprising a quick release mechanism assembled to the rotatable plate and the operation platform, so as to quickly mount the rotatable plate on the operation platform or quickly remove the first rotatable plate from the operation platform.

5. The portable auxiliary device as claimed in claim 4, wherein the quick release mechanism comprises:
a latching member including:
a rotatable portion perforating through the operation platform, and formed in a rounded periphery to make the rotatable portion rotatable with respect to the operation platform; and
a driving portion extended from the rotatable portion, and bored with a latching recess; and
a quick release bar perforating the rotatable plate to latch the latching recess when mounting the rotatable plate on the operation platform; and releasing from the latching recess when removing the rotatable plate from the operation platform.

6. The portable auxiliary device as claimed in claim 1, wherein the second rotatable assembly comprises:
a rotatable plate rotatably mounted on the operation platform, for mounting the second image catching device thereon; and
a bracket connected to the rotatable plate and assembled with the second optical guiding member.

7. The portable auxiliary device as claimed in claim 6, wherein the bracket is bored with an alignment slot for slidably aligning the second optical guiding member to make the projection of the second guiding light beam be coaxial with the projection of the second optical axis with respect to the operation plane.

8. The portable auxiliary device as claimed in claim 6, further comprising a quick release mechanism assembled to the rotatable plate and the operation platform, so as to quickly mount the rotatable plate on the operation platform or quickly remove the rotatable plate from the operation platform.

9. The portable auxiliary device as claimed in claim 8, wherein the quick release mechanism comprises:
a latching member including:
a rotatable portion perforating through the operation platform, and formed in a rounded periphery to make the rotatable portion be rotatable with respect to the operation platform; and
a driving portion extended from the rotatable portion, and bored with a latching recess; and
a quick release bar, perforating the rotatable plate to latch the latching recess when mounting the rotatable plate on the operation platform; and releasing from the latching recess when removing the rotatable plate from the operation platform.

10. The portable auxiliary device as claimed in claim 1, wherein at least one of the first optical guiding member and the second optical guiding member is a laser emitter, and at least one of the first guiding light beam and the second guiding light beam is a laser light beam.

11. The portable auxiliary device as claimed in claim 1, wherein the first image catching device is a camera, video camera, or digital video camera.

12. The portable auxiliary device as claimed in claim 1, wherein the second image catching device is a camera, video camera, or digital video camera.

13. The portable auxiliary device as claimed in claim 1, wherein the first image is a motion image or a static image.

14. The portable auxiliary device as claimed in claim 1, wherein the second image is a motion image or a static image.

15. The portable auxiliary device as claimed in claim 1, wherein the stereoscopic image is a motion image or a static image.
